(19) United States
(12) Patent Application Publication
(10) Pub. No.: US 2011/0097152 A1
(43) Pub. Date: Apr. 28, 2011

(54) HELICALLY-REINFORCED HORIZONTAL WATER-GATHERING PIPE HAVING MULTI-DIAMETER AND METHOD OF INSERTING THE HELICALLY-REINFORCED HORIZONTAL WATER-GATHERING PIPE

(76) Inventor: Seung Hyun Kim, Gyeongsan-si (KR)

(21) Appl. No.: 12/911,976

(22) Filed: Oct. 26, 2010

(30) Foreign Application Priority Data
Oct. 28, 2009 (KR) 10-2009-0102842

(51) Int. Cl. E02B 3/00; F16L 1/16

(52) U.S. Cl. 405/52; 405/169

(57) ABSTRACT

Provided are a helically-reinforced horizontal water-gathering pipe having a multi-diameter, which is used in a riverbed filtration system that is installed in a predetermined depth of a riverbed to receive filtered water that is filtered through an aquifer and transfer the filtered water to a collector well or a collector trench, the helically-reinforced horizontal water-gathering pipe including: drain pipes including a plurality of inflow holes through which the filtered water flows, wherein the drain pipes have different diameters and each of the drain pipes having a larger diameter is disposed near the collector well or the collector trench; and at least one reinforcing screw helically protruded along an outer perimeter of each of the drain pipes, and a method of inserting the helically-reinforced horizontal water-gathering pipe. Since the helically-reinforced horizontal water-gathering pipe includes the reinforcing screw on the outer perimeter of each drain pipe, the helically-reinforced horizontal water-gathering pipe may be directly inserted into and installed in the aquifer by rotating the helically-reinforced horizontal water-gathering pipe. Accordingly, the helically-reinforced horizontal water-gathering pipe is easily and quickly installed without having to use an out-casing. Also, the reinforcing screw improves a structural strength of the helically-reinforced horizontal water-gathering pipe, thereby increasing durability of the helically-reinforced horizontal water-gathering pipe. Moreover, since a diameter of the helically-reinforced horizontal water-gathering pipe increases toward the collector well, an inflow efficiency of the filtered water may be prevented from being deteriorated even when a length of the helically-reinforced horizontal water-gathering pipe is long.

### CROSS-REFERENCE TO RELATED PATENT APPLICATION

This application claims the benefit of Korean Patent Application No. 10-2010-0102842, filed on Oct. 28, 2010, in the Korean Intellectual Property Office, the disclosure of which is incorporated herein in its entirety by reference.

### BACKGROUND OF THE INVENTION

1. Field of the Invention

The present invention relates to a horizontal water-gathering pipe used in a riverbed filtration system, and more particularly, to a helically-reinforced water-gathering pipe used in a riverbed filtration system that is installed in a predetermined depth of a riverbed to receive filtered water that is filtered through an aquifer and transfer the filtered water to a collector well or a collector trench, and a method of inserting the helically-reinforced water-gathering pipe.

2. Description of the Related Art

Generally, an indirect water intake system for extracting clean water by passing river water or lake water through a soil layer indicates a water intake system that directly gathers water through a vertical well, such as a conventional well, or that gathers filtered water to a collector well through a water-gathering pipe. The indirect water intake system may be classified into a riverbank filtration system and a riverbed filtration system based on a distance between raw water and a filtered-water gathering device.

In the riverbank filtration system, a filtered-water gathering device is installed far from raw water. The riverbank filtration system is mostly used in Europe where a permeability of stratum is large, and focuses more on water quality than the production rate of filtered water.

On the other hand, the riverbed filtration system that gathers filtered water by installing a water-gathering pipe at a riverbed is subject to post-processing the filtered water, and focuses more on the production rate than a quality of the filtered water. Since a filtered-water gathering device is installed near raw water, the production rate of the filtered water is high and the dissolution of secondary contaminants, such as iron or manganese, is low (“Model Development for the Design of Pumping Well Locations in Bank Filtration” by Seung Hyun KIM, Young Kyu PARK, and Chul Hee LEE, Journal of Korean Society of Environmental Engineers, 20, pp. 83-92, 1998; “Comparison of Riverbank and Riverbed Filtrations in Korea” by Seung Hyun KIM, Journal of Korean Society of Environmental Engineers, 29, pp. 1154-1162, 2007).

FIGS. 1 and 2 are respectively a plan view and a cross-sectional view of a plurality of general horizontal water-gathering pipes 10 radially disposed for riverbed filtration.

The filtered-water gathering device, i.e., a water-gathering pipe, of the riverbed filtration system is generally installed horizontally at about 3 to 7 m beneath the riverbed or lakebed. In other words, referring to FIGS. 1 and 2, the water-gathering pipes 10 as a perforated pipe constituting drain pipes may be radially installed from the collector well 20. R, L, W and S denote a river, a land, a filtered water and a river water surface, respectively.

Examples of a method of installing water-gathering pipe of the riverbed filtration system include the Ranney method, the projection pipe method, and the gravel packing method (Riverbank filtration-Improving source-water quality, edited by Ray, C., Melin, G., and Linsky, R. B., Kluwer Academic Publishers, 2002).

First, the Ranney method is the oldest method and is performed by directly inserting a screen for the water-gathering pipe from a caisson to an aquifer. The Ranney method is developed in US in early 20s for oil drilling. In the Ranney method, the screen is inserted into the aquifer by hydraulically applying pressure on the screen and as the screen is pushed forward, fine textured particles around the screen flow into the screen and are discharged with water. Accordingly, friction generated while the screen is pushed forward is reduced as soil around the screen becomes loose, and thus the screen is easily pushed forward. Moreover, as the screen is pushed forward, a filter layer, in which only coarse-grained particles remain, is automatically formed, and thus a well-efficiency improves. The Ranney method is different from the gravel packing method where a filter material is deliberately injected. However, in the Ranney method, since the screen is inserted into the aquifer by hydraulically pressurizing the screen, an increase in the open area ratio of the screen is limited in order to maintain the strength of the screen, and the screen is thick so as to endure a big momentum. Consequently, resistance generated when filtered water passes through inflow holes of the screen is high, and thus the well-efficiency is decreased. Also, since a plurality of inflow holes are formed on the screen, the strength of the screen is decreased as much, and thus it becomes difficult to install a long horizontal water-gathering pipe and it takes long to install the screen since the screen is slowly and hydraulically inserted.

Next, the projection pipe method is performed by horizontally inserting a hollow pipe (out-casing) into an aquifer, removing soil particles in the out-casing, pushing a screen having a smaller diameter than the out-casing into the out-casing, and then drawing and removing the out-casing while leaving the screen to use it as a water-gathering pipe.

The projection pipe method may be completed quicker than the Ranney method since a strong non-perforated pipe is inserted into and excavates an aquifer. Also, since a length of a collector well may be long, a large-capacity collector well may be installed in a short time. In addition, since a composition of soil particles discharged when the out-casing is pushed in may be pre-determined, an optimum size of inflow holes on the screen may also be pre-determined. However, in the projection pipe method, it is very difficult to draw the out-casing after installing the water-gathering pipe, a well may be unsuccessful as the screen may be damaged easily while drawing the out-casing, and material is needed more than the Ranney method.

Lastly, the gravel packing method uses a fine textured soil layer as an aquifer. However, since filter materials (coarse sand to small gravels) are packed between an external pipe and an internal screen, a process of packing the filter materials after installing the internal screen and a process of drawing the external pipe after packing the filter materials are more difficult than the projection pipe method.

Meanwhile, the production rate of a collector well is determined based on three elements, i.e., conveyance of an aquifer, conveyance through inflow holes of a screen for a water-gathering pipe, and axial conveyance in a horizontal water-gathering pipe. Here, the production rate of the collector well is controlled by the smallest conveyance among the three elements. Here, the conveyance of the aquifer is a natural condition whereas an open area ratio and diameter of the screen may be artificially adjusted.

Permeability of an aquifer in Europe or US is about 10 to 100 times higher than that of South Korea, and thus an open area ratio and diameter of a water-gathering pipe used in Europe or US need to be large so as to adjust water-gathering capacity of a well (the conveyance through the inflow holes and the axial conveyance in the horizontal water-gathering pipe) to large conveyance of an aquifer. On the other hand, since a large amount of filtered water may be obtained even when a length of a water-gathering pipe is short, the length of the water-gathering pipe does not need to be long (Riverbank filtration-Improving source-water quality, edited by Ray, C., Melin, G., and Linsky, R. B., Kluwer Academic Publishers, 2002). Accordingly, it may be better to install a screen by the Ranney method in such a stratum condition.

However, in Korea, a permeability, i.e., conveyance, of an aquifer is low. Aquifers in most Europe and US where collector wells were developed have big particles and high permeabilities since the aquifers are ice gorge layers formed during the glacial epoch, but aquifers in Korea have fine particles and low permeabilities since the aquifers are formed of alluvial layers, which is formed by particles eroded and stacked by rainwater, as Korea did not undergo the glacial epoch (“Comparison of Riverbank and Riverbed Filtrations in Korea” by Seung Hyun KIM, Journal of Korean Society of Environmental Engineers, 29 (10 horizontal water-gathering pipe), pp. 1154-1162, 2007).

Thus, in order to obtain a large amount of filtered water in Korea, a riverbed filtration method, wherein a long water-gathering pipe is installed in an aquifer below river water, may be applied. In order to install the long water-gathering pipe, the projection pipe method or the gravel packing method in the case of fine textures may be used instead of the Ranney method. Moreover, since the projection pipe method and the gravel packing method install an external pipe, i.e., an out-casing while rotationally pushing the out-casing, an excavation speed is high and obstacles such as boulders are crushed, thereby reducing an entire excavation construction period. Thus, the projection pipe method and the gravel packing method are widely used in Korea.

In other words, although it is easy to install a screen by using the Ranney method, the Ranney method is barely used in Korea since a pushing speed of the screen is slow as the screen is installed not rotationally but hydraulically, a thick screen is used as the screen has to directly endure a strong force, and an open area ratio of the screen should not be increased beyond some limit.

Meanwhile, economic feasibility increases as the capacity of a collector well is increased because it is better in terms of construction and maintenance to install a less number of large capacity collector wells than installing a large number of small capacity collector wells. In Europe or US the production rate of the collector well can be easily increased with only minor increase of the length of the gathering pipe since the aquifer permeability is excellent. However in Korea, since the permeability is low, a length of a water-gathering pipe is inevitably increased to build a large capacity collector well even for a riverbed filtration. Thus, the projection pipe method using an out-casing, or the gravel packing method are more likely to be used in Korea. However, as the length of the screen increases, it becomes more and more difficult to draw the out-casing.

Also, an axial flow in the screen (or gathering pipe) is exposed to a more resistance than the flow in a usual pipe flow because the filtered water radially passing through the inflow holes enters the gathering pipe perpendicular to the axial flow direction, which causes additional resistance to the axial flow. When the water-gathering pipe is long and thus the flow rate of the filtered water flowing into the screen increases, the axial flow rate in the screen is increased. Specifically, the flow rate of the filtered water is increased near the collector caisson. When the flow rate in a horizontal water-gathering pipe having a uniform cross-sectional area increases, a flow speed is increased. When the flow speed increases, the resistance to the axial flow becomes very high since the resistance increases in proportion to the square of the flow speed.

Here, the riverbed filtration system that gathers filtered water by installing a water-gathering pipe at a riverbed is followed by a post-processing of the filtered water before the water is supplied to the final consumers, and focuses more on the production rate than the quality of the filtered water. Since a filtered-water gathering device is installed near the source water, the production rate of the filtered water is high and the dissolution of the secondary contaminants, such as iron or manganese, is low (“Model Development for the Design of Pumping Well Locations in Bank Filtration” by Seung Hyun KIM, Young Kyu PARK, and Chul Hee LEE, Journal of Korean Society of Environmental Engineers, 20, pp. 83-92, 1998; “Comparison of Riverbank and Riverbed Filtrations in Korea” by Seung Hyun KIM, Journal of Korean Society of Environmental Engineers, 29, pp. 1154-1162, 2007).

Such a riverbed filtration system includes a collector well, such as a caisson, or a collector trench, to which a conduct pipe or a pump is installed, and a water-gathering pipe, which is horizontally installed at a predetermined depth of a riverbed to receive filtered water that is filtered through an aquifer and transfer the filtered water to the collector well or the collector trench.

In Korea, the riverbed filtration system is mostly installed by pushing a hollow pipe (out-casing) into an aquifer, removing soil particles in the out-casing, pushing a water-gathering pipe smaller than the out-casing in diameter into the out-casing, and then removing the out-casing while leaving the water-gathering pipe.

However in Korea, since conveyance of the aquifer is low, a long water-gathering pipe should be installed so as to obtain a large amount of filtered water. However, when the long water-gathering pipe is used, it is difficult to install and remove the out-casing.

Also, even when the long water-gathering pipe is installed, the flow rate of the filtered water flowing into the long water-gathering pipe increases, and thus the axial flow velocity increases. Thus, an inflow rate of the filtered water decreases.

FIG. 3 is a diagram for describing a water head distribution along the horizontal water-gathering pipe 10 of the riverbed filtration system from the collector well 20.

Referring to FIG. 3, a driving force for the filtered water, which is filtered as river water passes through an aquifer 1, to flow into the horizontal water-gathering pipe 10 and to the collector well 20 or a collector trench in the riverbed filtration system is the difference between the surface of the river water and the water head of the horizontal water-gathering pipe 10 (h(x)). So, in the actual riverbed filtration system, the water head of the horizontal water-gathering pipe becomes higher with the distance from the collector well 20, and thus the inflow rate of the filtered water decreases in the horizontal water-gathering pipe 10 with the distance from the collector well 20.

When the flow rate of the filtered water flowing into the horizontal water-gathering pipe 10 increases due to a long length of the horizontal water-gathering pipe 10, the axial flow rate of the filtered water is also increased. When the axial flow rate increases as such, frictional resistance to axial flow of the filtered water is increased, and thus an inflow efficiency of the filtered water to the horizontal water-gathering pipe 10 is decreased. Here, the frictional resistance is enhanced as a flow of the filtered water flowing through the inflow holes of the horizontal water-gathering pipe 10 is perpendicular to the axial flow of the filtered water flowing in the horizontal water-gathering pipe 10.

In other words, in order to obtain a large amount of filtered water, the length of the horizontal water-gathering pipe 10 should be increased in the riverbed filtration system. However, in this case, an excavation process is difficult to be performed and is complex, since the out-casing is inserted into the aquifer 1 first, the horizontal water-gathering pipe 10 is inserted into the out-casing, and then the out-casing is removed. Also in the riverbed filtration system, the inflow rate of the filtered water decreases with the distance from the collector well 20, and thus the overall inflow efficiency of the filtered water in the riverbed filtration system is decreased.

### SUMMARY OF THE INVENTION

The present invention provides a helically-reinforced horizontal water-gathering pipe having a multi-diameter used in a large-capacity riverbed filtration system, wherein the helically-reinforced horizontal water-gathering pipe is easily installed by directly inserting the helically-reinforced horizontal water-gathering pipe into an aquifer by rotating the helically-reinforced horizontal water-gathering pipe without having to use an out-casing, and an inflow efficiency of the filtered water is improved even when a length of the helically-reinforced horizontal water-gathering pipe is long.

The present invention also provides a method of inserting the helically-reinforced horizontal water-gathering pipe.

According to an aspect of the present invention, there is provided a helically-reinforced horizontal water-gathering pipe having a multi-diameter, which is used in a riverbed filtration system that is installed in a predetermined depth of a riverbed to receive filtered water that is filtered through an aquifer and transfer the filtered water to a collector well or a collector trench, the helically-reinforced horizontal water-gathering pipe including: drain pipes including a plurality of inflow holes through which the filtered water flows, wherein the drain pipes have different diameters and each of the drain pipes having a larger diameter is disposed near the collector well or the collector trench; and at least one reinforcing screw helically protruded along an outer perimeter of each of the drain pipes.

The helically-reinforced horizontal water-gathering pipe may further include at least one expanding pipe that is disposed between the drain pipes to connect each of the drain pipes and has a diameter that gradually increases.

Each of the drain pipes and the reinforcing screw may be combined to each other by welding. An open area ratio of the drain pipes may decrease toward the collector well or the collector trench.

According to another aspect of the present invention, there is provided a method of inserting a helically-reinforced horizontal water-gathering pipe having a multi-diameter, the method including: preparing a helically-reinforced horizontal water-gathering pipe having a multi-diameter, which includes drain pipes including a plurality of inflow holes, wherein the drain pipes have different diameters, and at least one reinforcing screw helically protruded along an outer perimeter of each of the drain pipes; preparing a rotating unit for rotating and pressing the helically-reinforced horizontal water-gathering pipe; disposing the helically-reinforced horizontal water-gathering pipe in such a way that the drain pipe having a small diameter is inserted into an aquifer, at a predetermined depth of a riverbed; and inserting the helically-reinforced horizontal water-gathering pipe into the aquifer by rotating and pressing the helically-reinforced horizontal water-gathering pipe by using the rotating unit so that the reinforcing screw excavates the aquifer.

### BRIEF DESCRIPTION OF THE DRAWINGS

The above and other features and advantages of the present invention will become more apparent by describing in detail exemplary embodiments thereof with reference to the attached drawings in which:

FIGS. 1 and 2 are respectively a plan view and a cross-sectional view of a plurality of general horizontal water-gathering pipes radially disposed for riverbed filtration;

FIG. 3 is a diagram for describing a water head distribution along a general horizontal water-gathering pipe of a riverbed filtration system;

FIG. 4 is a diagram of a helically-reinforced horizontal water-gathering pipe having a multi-diameter, according to an embodiment of the present invention; and

FIG. 5 is a flowchart illustrating a method of inserting the helically-reinforced horizontal water-gathering pipe of FIG. 4.

### DETAILED DESCRIPTION OF THE INVENTION

Hereinafter, the present invention will be described more fully with reference to the accompanying drawings, in which the exemplary embodiments of the invention are shown.

FIG. 4 is a diagram of a helically-reinforced horizontal water-gathering pipe 100 having a multi-diameter, according to an embodiment of the present invention.

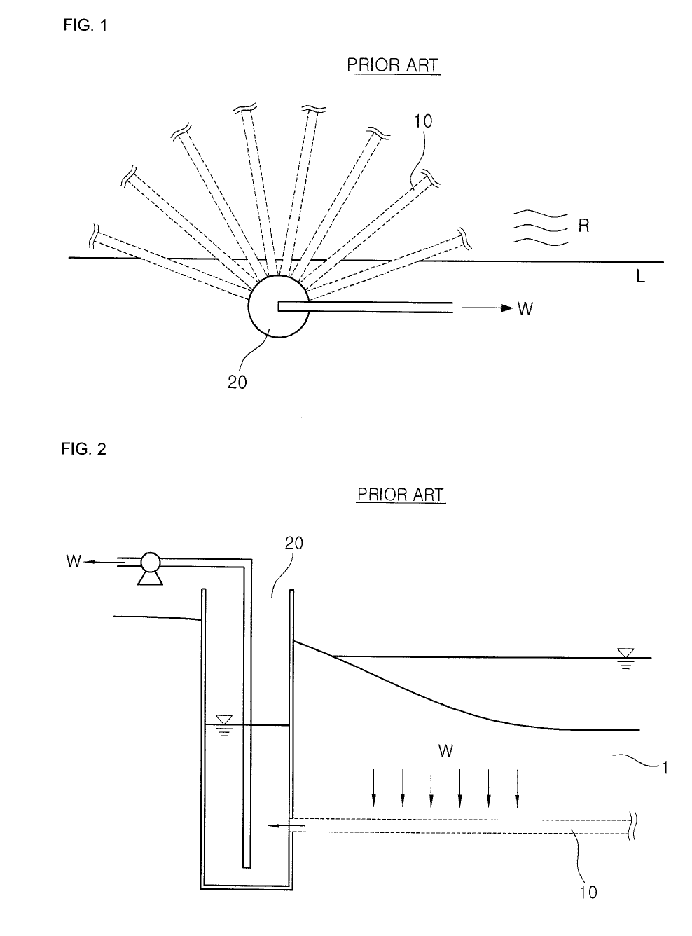

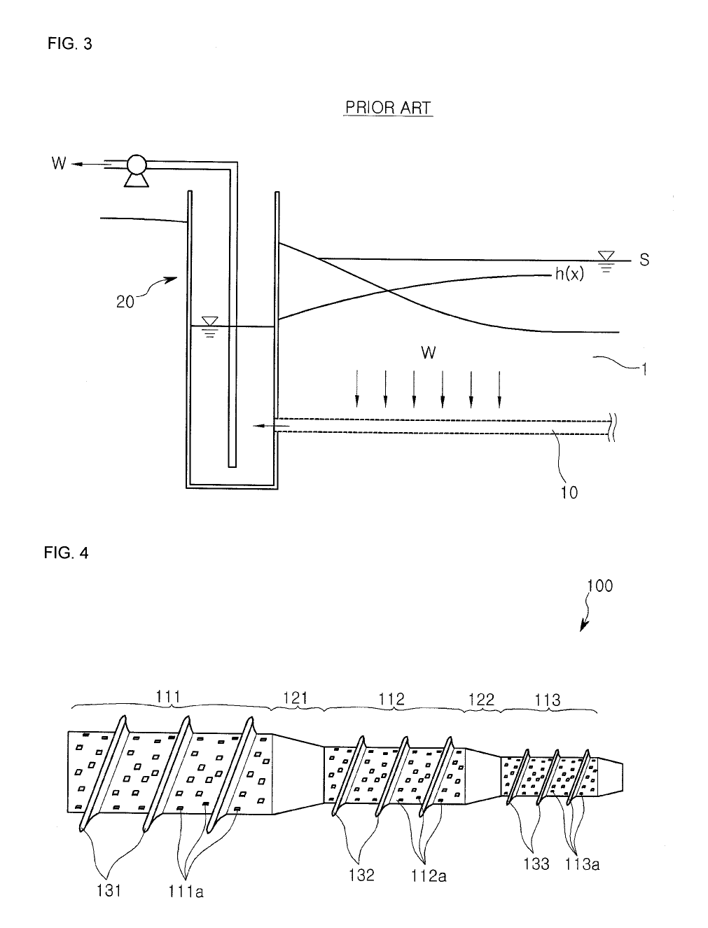

Referring to FIG. 4, the helically-reinforced horizontal water-gathering pipe 100 is installed at a predetermined depth of a riverbed to receive filtered water that is filtered through an aquifer (refer to the aquifer 1 of FIG. 1 or 2) and transfer the filtered water to a collector well (refer to the collector well 20 of FIG. 1 or 2) or a collector trench, and has a diameter that increases toward the collector well or the collector trench. Accordingly, in the helically-reinforced horizontal water-gathering pipe 100, only the flow speed of the filtered water is reduced without reducing an axial flow rate of the filtered water by increasing the diameter of the helically-reinforced horizontal water-gathering pipe 100, thereby improving an inflow rate pattern of the filtered water in the entire length of the helically-reinforced horizontal water-gathering pipe 100. In other words, even when a water head has an almost horizontal curve, the axial flow rate is sufficiently high since the diameter is big, and thus the filtered water may be easily discharged.

So as to increase the diameter and easily manufacture the helically-reinforced horizontal water-gathering pipe 100, the helically-reinforced horizontal water-gathering pipe 100 includes a plurality of drain pipes 111 through 113, and at least one expanding pipe 121 and 122.

The drain pipes 111 through 113 have different diameters, and a plurality of inflow holes 111a through 113a are respectively formed on outer perimeters of the drain pipes 111 through 113 so that the filtered water flows into the drain pipes 111 through 113.

The expanding pipes 121 and 122 are respectively disposed between the drain pipes 111 and 112 and the drain pipes 112 and 113 having different diameters, and connect the drain pipes 111 through 113 as ends of the expanding pipe 121 are respectively connected to ends of the drain pipes 111 and 112, and ends of the expanding pipe 122 are respectively connected to ends of the drain pipes 112 and 113. Here, the expanding pipes 121 and 122 may have funnel shapes to connect the neighboring drain pipe 111 through 113 having different diameters, thereby reducing resistance with respect to the different diameters of the drain pipes 111 through 113. Also, the expanding pipes 121 and 122 may minimize a water head loss.

Accordingly, in the current embodiment of the present invention, the diameter of the helically-reinforced horizontal water-gathering pipe 100 is increased near the collector well, and thus the frictional loss of the water head in the entire section of the helically-reinforced horizontal water-gathering pipe 100 is reduced despite that a length of the helically-reinforced horizontal water-gathering pipe 100 is long. Accordingly, an inflow efficiency of the filtered water may be improved.

In other words, the inflow efficiency of the filtered water may be improved by only reducing a flow speed without reducing an axial flow rate, by increasing a cross-sectional area of the helically-reinforced horizontal water-gathering pipe 100 (flow rate=flow speed x cross-sectional area). Also, in the current embodiment of the present invention, since more power is loaded during the construction on the helically-reinforced horizontal water-gathering pipe 100 near a caisson, the cross-sectional area of the helically-reinforced horizontal water-gathering pipe 100 is large so that a thickness of the helically-reinforced horizontal water-gathering pipe 100 is not thick even near the caisson and the axial flow speed is not increased. However, at this time, since it is difficult to gradually increase the diameter of the helically-reinforced horizontal water-gathering pipe 100, the drain pipes 111 through 113 having the diameters that increase in a stepwise are used. However, large resistance is caused due to sudden cross-section changes in the connections of the drain pipes 111 through 113, and thus the large resistance is reduced by using the expanding pipes 121 and 122. By using the helically-reinforced horizontal water-gathering pipe 100 having the multi-diameter, the water head at the helically-reinforced horizontal water-gathering pipe 100 is almost identical to a water level at the caisson, and thus efficiency of a horizontal well may be increased.

Here, the helically-reinforced horizontal water-gathering pipe 100 may be formed of a stainless material that is capable of enduring a force and earth pressure according to an excavation process and is corrosion-resistant. However, a material of the helically-reinforced horizontal water-gathering pipe 100 is not limited thereto, and carbon steel having strength and durability to endure the earth pressure may be used.

An open area ratio of the helically-reinforced horizontal water-gathering pipe 100 may be decreased toward the collector well or collector trench. Since the diameter of the helically-reinforced horizontal water-gathering pipe 100 is increased, an open area may be maintained even if the open area ratio of the helically-reinforced horizontal water-gathering pipe 100 near the collector well is low. Also, accordingly, numbers of the inflow holes 111a through 113a that may weaken structural strength of the helically-reinforced horizontal water-gathering pipe 100 may be reduced near the collector well, and thus the structural strength of the helically-reinforced horizontal water-gathering pipe 100 near the collector well may be improved and the helically-reinforced horizontal water-gathering pipe 100 may endure a load due to the aquifer or the excavation process. Thus, it becomes easier to install the helically-reinforced horizontal water-gathering pipe 100 having a long length.

An open area ratio of the helically-reinforced horizontal water-gathering pipe 100 according to the current embodiment of the present invention will now be described in detail. The open area ratio of the helically-reinforced horizontal water-gathering pipe 100 may be in the range from 2% to 9%. The open area ratio is a lot small compared to 23% of an open area ratio of a water-gathering pipe widely used in US or Europe. Such a range of the open area ratio is determined considering a low production rate in Korea due to the aquifer having low conveyance, a speed of the filtered water passing through the inflow holes 111a through 113a, and the inflow rate of the filtered water according to the length of the helically-reinforced horizontal water-gathering pipe 100. The open area ratio of the helically-reinforced horizontal water-gathering pipe 100 may not be unnecessarily increased.

The helically-reinforced horizontal water-gathering pipe 100 according to the current embodiment of the present invention may have the diameter that increases toward the collector well or collector trench as described above, while including reinforcing screws 131 through 133 respectively along the outer perimeters of the helically-reinforced horizontal water-gathering pipe 100. The reinforcing screws 131 through 133 may be combined to the outer perimeter via welding or the like, but any method that strongly combines the reinforcing screws 131 through 133 to the outer perimeter may be used.

The reinforcing screws 131 through 133 distribute a force applied to the helically-reinforced horizontal water-gathering pipe 100 during the excavation process that rotates and pushes the helically-reinforced horizontal water-gathering pipe 100. Accordingly, the excavation process is easily performed while structurally reinforcing the helically-reinforced horizontal water-gathering pipe 100 without having to increase the thickness of the helically-reinforced horizontal water-gathering pipe 100. The reinforcing screws 131 through 133 are helically formed along the outer perimeter of the helically-reinforced horizontal water-gathering pipe 100. A thickness of the reinforcing screws 131 through 133 may be from about 3 to 5 mm, and a height of the reinforcing screws 131 through 133 may be from about 1 to 3 cm based on the diameter of the helically-reinforced horizontal water-gathering pipe 100. When the thickness and the height of the reinforcing screws 131 through 133 are respectively below 3 mm and 1 cm, it is difficult to reinforce the strength of the helically-reinforced horizontal water-gathering pipe 100 and easily perform the excavation process. On the other hand, when the thickness and the height of the reinforcing screws 131 through 133 are respectively above 5 mm and 3 cm, it may be inefficient to form the reinforcing screws 131 through 133 in terms of effects, such as manufacturing costs or the like.

According to the current embodiment of the present invention, the reinforcing screws 131 through 133 that are helically formed on the outer perimeter of the helically-reinforced horizontal water-gathering pipe 100 distribute a stress applied to the helically-reinforced horizontal water-gathering pipe 100 while performing the excavation process by rotating and pushing the helically-reinforced horizontal water-gathering pipe 100 forward. As a result, the structural durability of the helically-reinforced horizontal water-gathering pipe 100 is increased.

Meanwhile, the reinforcing screws 131 through 133 may not be formed on the expanding pipes 121 and 122.

As described above, since the reinforcing screws 131 through 133 are formed on the outer perimeter of the helically-reinforced horizontal water-gathering pipe 100, the structural strength of the helically-reinforced horizontal water-gathering pipe 100 may be increased, and thus the thickness of the helically-reinforced horizontal water-gathering pipe 100 may be decreased. Accordingly, the water head loss accompanied while the filtered water passes through the inflow holes 111a through 113a may be decreased, thereby improving the inflow efficiency of the helically-reinforced horizontal water-gathering pipe 100.

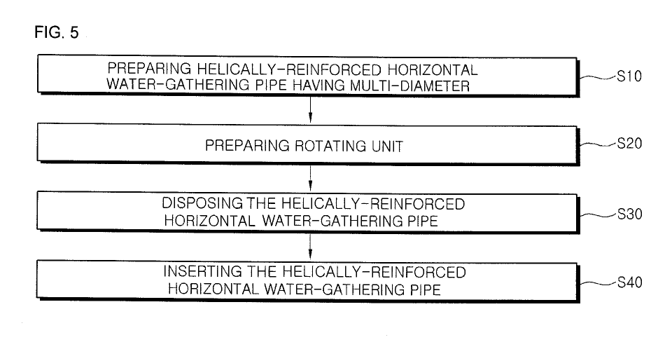

FIG. 5 is a flowchart illustrating a method of inserting the helically-reinforced horizontal water-gathering pipe 100 of FIG. 4, and the method will now be described with reference to FIG. 5.

First, a helically-reinforced horizontal water-gathering pipe having a multi-diameter is prepared in operation S10. Here, the helically-reinforced horizontal water-gathering pipe includes drain pipes including a plurality of inflow holes, wherein the drain pipes have different diameters, and at least one reinforcing screw helically protruded along an outer perimeter of each of the drain pipes. The helically-reinforced horizontal water-gathering pipe is substantially identical to the helically-reinforced horizontal water-gathering pipe 100 of FIG. 4, and thus details thereof are not repeated.

Then, a rotating unit for rotating and pressing the helically-reinforced horizontal water-gathering pipe is prepared in operation S20. Here, the rotating unit may be any unit that is connected to the drain pipe having a large diameter of the helically-reinforced horizontal water-gathering pipe and capable of axially rotating the helically-reinforced horizontal water-gathering pipe.

After preparing the helically-reinforced horizontal water-gathering pipe and the rotating unit, the helically-reinforced horizontal water-gathering pipe is disposed in such a way that the drain pipe having a small diameter of the helically-reinforced horizontal water-gathering pipe is inserted into an aquifer, at a predetermined depth of a riverbed, in operation S30.

Next, the helically-reinforced horizontal water-gathering pipe is inserted into the aquifer by rotating and pressing the helically-reinforced horizontal water-gathering pipe by using the rotating unit so that the reinforcing screw excavates the aquifer, in operation S40.

As described above, the helically-reinforced horizontal water-gathering pipe 100 includes the reinforcing screws 131 through 133 on the outer perimeter, and thus a series of conventional operations, such as excavating an aquifer to insert an out-casing, inserting a water-gathering pipe into an inner diameter surface of the out-casing, and then removing the out-casing, may not be performed. In other words, since the helically-reinforced horizontal water-gathering pipe 100 according to the current embodiment of the present invention directly excavates the aquifer by rotating, the helically-reinforced horizontal water-gathering pipe 100 is easily installed, has a quick installation speed since the momentum is excellent according to the rotation of the helically-reinforced horizontal water-gathering pipe 100 during the excavation process, and is economical as the installation and material costs are reduced.

In other words, when a riverbed filtration system is used in Korea where a permeability of an aquifer is low, difficulties of drawing an out-casing while installing a long water-gathering pipe by using a projection pipe method or a gravel packing method may be removed by including a reinforcing screw so that a horizontal water-gathering pipe directly excavates an aquifer. Accordingly, a process of drawing the out-casing is removed, and thus the horizontal water-gathering pipe is easily inserted into the aquifer. Also, according to the current embodiment of the present invention, a Ranney method, which mostly uses a short horizontal water-gathering pipe and is easily performed, may also be applied to install a long horizontal water-gathering pipe.

In other words, in the Ranney method, since a horizontal water-gathering pipe including inflow holes is directly pushed into an aquifer, it is structurally difficult to install a long water-gathering pipe. Thus, a long water-gathering pipe having a thick thickness is used for the Ranney method, which decreases a well-efficiency as a water head loss increases while filtered water passes through the thick inflow holes. However, according to an embodiment of the present invention, reinforcing screws are formed on an outer perimeter of a horizontal water-gathering pipe, and thus the horizontal water-gathering pipe may be structurally reinforced without having to increase a thickness of the horizontal water-gathering pipe.

Also, according to the current embodiment of the present invention, efficiency deterioration of a horizontal well caused by using a long horizontal water-gathering pipe may be prevented, a water level drawdown in a collector well may be uniformly transmitted to the long horizontal water-gathering pipe without large distortion, the long horizontal water-gathering pipe is structurally improved to be applied to the

Ranney method, and well-efficiency deterioration caused in a long horizontal well may be prevented.

A helically-reinforced horizontal water-gathering pipe having a multi-diameter, and a method of inserting the helically-reinforced horizontal water-gathering pipe have following effects.

First, since a water-gathering pipe includes reinforcing screws on an outer perimeter of the water-gathering pipe and the water-gathering pipe is directly inserted into an aquifer by rotating the water-gathering pipe, an out-casing is not required. Thus, it is easy to install the water-gathering pipe, an installation speed is increased, and it is economical since process expenses are reduced.

Second, since the reinforcing screws are formed on the outer perimeter of the water-gathering pipe, structural strength of the water-gathering pipe can be improved, and thus a thickness of the water-gathering pipe can be reduced. Accordingly, friction between filtered water and inflow holes while the filtered water passes through the inflow hole can be reduced, thereby reducing a water head loss. Thus, an inflow efficiency of the water-gathering pipe can be improved.

Third, since a diameter of the water-gathering pipe increases toward a collector well, deterioration of an inflow efficiency of the filtered water can be prevented even when a length of the water-gathering pipe is long, and deterioration of strength of the water-gathering pipe and formation of unnecessary inflow holes are prevented since an open area ratio can be reduced.

Fourth, material costs are reduced since an out-casing is not required, and a construction work is easy since an operation of drawing the out-casing is omitted.

Fifth, efficiency deterioration of a horizontal well, which is inevitable when a long water-gathering pipe is used, can be prevented, thereby evenly using the aquifer and obtaining filtered water having best quality. Moreover, since a water head of the entire section of the long water-gathering pipe and a water level of a caisson are almost the same, riverbed filtered water having good quality may be obtained by evenly using a thin aquifer.

Sixth, since a screen is directly inserted into the aquifer while rotating the screen like a screw, a water-gathering pipe may be installed quicker than when the Ranney method is used. In other words, in the Ranney method, a front part of the screen, which is already inserted into the aquifer, does not generate momentum but is passively pushed in by a rear part of the screen, and thus it is difficult to push the screen into the aquifer. However, in a water-gathering pipe including helically-reinforced screws of the present invention, since the helical screws generate momentum by rotation, momentum is generated in the entire screen installed in an aquifer, and thus the screen is pushed into the aquifer easily and quickly.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A helically-reinforced horizontal water-gathering pipe having a multi-diameter, which is used in a riverbed filtration system that is installed in a predetermined depth of a riverbed to receive filtered water that is filtered through an aquifer and transfer the filtered water to a collector well or a collector trench, the helically-reinforced horizontal water-gathering pipe comprising:
drain pipes comprising a plurality of inflow holes through which the filtered water flows, wherein the drain pipes have different diameters and each of the drain pipes having a larger diameter is disposed near the collector well or the collector trench; and
at least one reinforcing screw helically protruded along an outer perimeter of each of the drain pipes.

2. The helically-reinforced horizontal water-gathering pipe of claim 1, further comprising at least one expanding pipe that is disposed between the drain pipes to connect each of the drain pipes and has a diameter that gradually increases.

3. The helically-reinforced horizontal water-gathering pipe of claim 2, wherein each of the drain pipes and the reinforcing screw are combined to each other by welding, and the at least one expanding pipe and the drain pipes are welded to each other.

4. The helically-reinforced horizontal water-gathering pipe of claim 1, wherein each of the drain pipes and the reinforcing screw are combined to each other by welding.

5. The helically-reinforced horizontal water-gathering pipe of claim 1, wherein an open area ratio of the drain pipes decreases toward the collector well or the collector trench.

6. The helically-reinforced horizontal water-gathering pipe of claim 2, wherein an open area ratio of the drain pipes decreases toward the collector well or the collector trench.

7. The helically-reinforced horizontal water-gathering pipe of claim 5, wherein the open area ratio is in the range from 2% to 9%.

8. The helically-reinforced horizontal water-gathering pipe of claim 6, wherein the open area ratio is in the range from 2% to 9%.

9. The helically-reinforced horizontal water-gathering pipe of claim 2, wherein the drain pipes, the reinforcing screw, and the at least one expanding pipe are formed of stainless steel.

10. A method of inserting a helically-reinforced horizontal water-gathering pipe having a multi-diameter, the method comprising:
preparing a helically-reinforced horizontal water-gathering pipe having a multi-diameter, which comprises drain pipes comprising a plurality of inflow holes, wherein the drain pipes have different diameters, and at least one reinforcing screw helically protruded along an outer perimeter of each of the drain pipes;
preparing a rotating unit for rotating and pressing the helically-reinforced horizontal water-gathering pipe;
disposing the helically-reinforced horizontal water-gathering pipe in such a way that the drain pipe having a small diameter is inserted into an aquifer, at a predetermined depth of a riverbed; and
inserting the helically-reinforced horizontal water-gathering pipe into the aquifer by rotating and pressing the helically-reinforced horizontal water-gathering pipe by using the rotating unit so that the reinforcing screw excavates the aquifer.

11. The method of claim 10, wherein the helically-reinforced horizontal water-gathering pipe further comprises at least one expanding pipe that is disposed between the drain pipes to connect each of the drain pipes and has a diameter that gradually increases.

12. The method of claim 11, wherein an open area ratio of the drain pipes decreases toward a collector well or a collector trench.

13. The method of claim 10, wherein an open area ratio of the drain pipes decreases toward a collector well or a collector trench.

14. The method of claim 10, wherein the open area ratio is in the range from 2% to 9%.

15. The method of claim 11, wherein the open area ratio is in the range from 2% to 9%.
